(19) United States
(12) Patent Application Publication
(10) Pub. No.: US 2008/0026224 A1
(43) Pub. Date: Jan. 31, 2008

(54) Radiation curable inks

(76) Inventor: David H. Blank, Lebanon, NH (US)

Correspondence Address: FISH & RICHARDSON PC, P.O. BOX 1022, MINNEAPOLIS, MN, 55440-1022, US

(21) Appl. No.: 11/493,139

(22) Filed: Jul. 26, 2006

(51) Int. Cl. B32B 9/00; B08B 3/12; B32B 9/04

(52) U.S. Cl. 428/411.1; 134/1

(57) ABSTRACT

Ink compositions and methods of marking objects are described.

### TECHNICAL FIELD

This invention relates to ink compositions and methods of marking objects.

### BACKGROUND

In many packaging processes, it is desirable to mark the package with information relating to the lot number or date of processing. Markings that are can be affected with speed an accuracy are desirable. In instances where the packaging is for a food product, it is also desirable that the components of the marking are generally recognized as safe.

### SUMMARY

The invention relates to methods of marking an object, using a radiation curable (e.g., a radiation triggered reaction) colorant. The methods can be used, for example, to mark a packaging material, such as a packaging for a food product.

In one aspect, the invention features a method of unmasking a masked colorant. The method includes exposing an object coated with the masked colorant to radiation having a power less than 10 W and a wavelength of greater than about 800 nm thereby unmasking the masked colorant to produce a change in color of the object coated with the masked colorant.

In some embodiments, the radiation has a power of less than about 5 W, for example a power of about 1 W.

In some embodiments, the radiation has an energy less than about 7 J/cm², for example, about 1 J/cm².

In some embodiments, the wavelength of the radiation is greater than about 900 nm or 1000 nm, for example, the wavelength of radiation is between about 1050 nm and about 1075 nm.

In some embodiments, the masked colorant is substantially free of inorganic salts.

In some embodiments, the masked colorant is an organic colorant.

In some embodiments, the masked colorant is a protected colorant and the unmasking comprises the deprotection of a protected colorant, for example, an indigo precursor, such as an indigo compound in the leuco form, e.g., a protected leuco form comprising a carbonate protecting group, an ethyl carbonate or a t-butyl carbonate, a silyl protecting group (e.g., a TMS or TIPS protecting group).

In some embodiments, the masked colorant is a methylene blue precursor, such as benzyol leucomethlene blue.

In some embodiments, the masked colorant has been layered with an inorganic salt, such as a titanium salt TiO₂ or other inorganic salts such as CaCO₃ or ZnO.

In some embodiments, the object comprises multiple layers and the coating of masked colorant is positioned between two layers, for example, the coating of masked colorant is not directly open to air.

In some embodiments, the masked colorant is a component of a composition.

In some embodiments, the composition is substantially free of organic solvent.

In some embodiments, the composition is a hot melt ink.

In some embodiments, the composition is a UV curable ink.

In some embodiments, the composition is a water based ink.

In some embodiments, the unmasked colorant produces an indicia on the object, for example, a date of packaging, a date of expiration, or a lot number.

In some embodiments, the object is a package for a foodstuff.

In some embodiments, the radiation is laser radiation.

In another aspect, the invention features a multilayered object, the object including a first layer and a second layer; and a masked colorant between the first layer and second layer.

In some embodiments, the first layer is a laminate layer.

In some embodiments, the second layer is a base layer.

In some embodiments, the masked colorant is substantially free of inorganic salts.

In some embodiments, the masked colorant is an organic colorant, such as indigo blue or methylene blue.

In some embodiments, the object is a packaging for foodstuffs.

The details of one or more embodiments of the invention are set forth in the accompanying drawings and the description below. Other features, objects, and advantages of the invention will be apparent from the description and drawings, and from the claims.

### DETAILED DESCRIPTION

The invention relates to methods of printing using a radiation-curable colorant, creating a marking on a substrate by unmasking a masked colorant, for example a colorless colorant. The masked colorant is generally a component in an ink composition.

Ink Compositions:

Any type of ink composition can be used to impart a marking on an object. An ink composition can be a water-based, solvent-based, or curable ink, any of which can be a solution or dispersion. Preferred ink compositions include flexographic inks, hot melt inks, hybrid hot melt inks, and gravure inks. The components of the ink composition can vary, for example, depending on the object that is being marked with the ink composition and the use of the object after printing.

Flexographic inks are generally fast drying and have a low viscosity. The inks are formulated to lie on the surface of nonabsorbent substrates and solidify when solvents are removed. Solvents are generally removed with heat, unless U.V. curable inks are used. Hot melts inks are generally solid at room temperature and liquid at temperatures above room temperatures, and are often used, for example, in digital to print methods. Gravure inks are generally fluid inks with a very low viscosity that allows them to be drawn into the engraved cells in a cylinder then transferred onto a substrate, and are commonly used for printing labels and packaging.

Embodiments of the ink composition generally include a colorant, a binder, a dispersant, and an adhesive. In instances where the ink composition is a curable ink composition, for example, a UV curable ink composition a polymerizeable material and a photo-initiator can also be included.

Colorant:

The colorant is a masked colorant, which becomes unmasked by exposure to radiant energy. Upon exposure to sufficient energy, the masked colorant, undergoes a chemical reaction, which shifts the masked colorant from a state where the color is either absent or reduced to an unmasked state where the colorant is in a colored chemical form. Masked colorants include those in the leuco form. A masked colorant in the leuco form is generally protected, for example such that upon exposure to sufficient radiation, the colorant is thermally deprotected, and the leuco form of the colorant is oxidized to provide a colored form of the colorant. Leuco indigo and leuco methylene blue are preferred masked colorants. Leuco indigo is an especially preferred masked colorant.

Preferred protecting groups include carbonate protecting groups such as ethyl carbonate, silicon protecting groups such as TMS, TiPS, and TBS, and benzyl protecting groups such as benzoyl. Other O-protecting groups (for example, acetyl: both the acetyl- and the ethyl acetoacetyl-O-protected indigo compounds have been reported previously: Setsune, J.-I, et al., J. Chem. Soc. Perkin Trans. I, 1984, 2305) on indigo could be considered as they may serve to lower the energy requirements for such a transformation.

The masked colorants of the invention are beneficial because they generally do not require the use of a solvent to produce a color. For example, because the masked colorant does not require reacting with a second component to transform into a colored state, no solution is required to produce a color.

Binder

The inks can include one or more binders, for example natural or synthesized resins such as polyvinyl alcohol, casein, starch, methyl cellulose, ethyl cellulose, acrylic resin, styrene-butadiene latex, polyvinyl butyral and the like.

Polymerizable Monomers

The inks can contain one or more polymerizable monomers, and optionally one or more diluents. The polymerizable monomers and the diluents can be mono-functional, di-functional, and tri- or higher functional material. The mono-, di-, tri-, and higher functional materials have, respectively, one, two, three, or more unsaturated carbon-carbon groups which are polymerizable by irradiating photoinitiators that are chemically activated when exposed to radiation, e.g., ultraviolet light radiation. Examples of the unsaturated carbon-carbon groups include vinyl and vinylidene groups. The polymerizable monomers can include di-functional, and tri- or higher functional materials, and the diluents include mono- and di-functional materials. Preferred inks include at least about 40%, more preferably from about 60% to about 90%, by weight of the polymerizable monomers and the diluents. In some embodiments, the inks include greater than or equal to about 40%, 45%, 50%, 55%, 60%, 65%, 70%, 75%, 80%, 85%, 90%, or 95% by weight of the polymerizable monomers and the diluents; and/or less than or equal to 95%, 90%, 85%, 80%, 75%, 70%, 65%, 60%, 55%, 50%, or 45% by weight of the polymerizable monomers and the diluents.

A mono-functional material can contain a single monomer or a mixture of monomers. The mono-functional material can be a straight or branched chain acrylate of an alcohol, or an acrylate of cyclic or polycyclic alkanols. Examples of the mono-functional materials include long chain aliphatic acrylates (e.g., lauryl acrylate or stearyl acrylate) and acrylates of alkoxylated alcohols (e.g., 2-(2-ethoxyethoxy)-ethyl acrylate. The mono-functional material need not necessarily be an acrylate. For example, methacrylate, vinyl, vinyl ether, or 1-propenyl ether may be used.

A di-functional material can contain a single monomer or a mixture of monomers. The di-functional material can be a diacrylate of a glycol or a polyglycol. Examples of the diacrylates include the diarylates of diethylene glycol, hexanediol, dipropylene glycol, tripropylene glycol, cyclohexane dimethanol (Sartomer CD406), and polyethylene glycols.

A tri- or higher functional material can contain a single monomer or a mixture of monomers. Examples of tri- or higher functional materials include tris(2-hydroxyethyl)-isocyanurate triacrylate (Sartomer SR386), dipentaerythritol pentaacrylate (Sartomer SR399), and alkoxylated acrylates (e.g., ethoxylated trimethylolpropane triacrylates (Sartomer SR454), propoxylated glyceryl triacrylate, and propoxylated pentaerythritol tetraacrylate).

Another example is a mixture of materials including epoxy acrylate, polyamide, monomers, and optionally acrylated polyamide, such as via Michael addition. Such a mixture is available as RM-370 from Cognis (Cincinnati, Ohio) and are described in U.S. Pat. Nos. 5,804,671, 5,889,076, 6,239,189, and 6,316,517, all hereby incorporated by reference in their entirety.

The inks may also contain one or more multi-functional oligomers or polymers. The oligomer or polymer can contain any suitable compound or mixture of compounds that contain one or more unsaturated carbon-carbon bonds, and may react with monomers upon radiation curing. Examples of the oligomers or polymers include polyacrylates such as urethane acrylates and epoxy acrylates.

The combination of the polymerizable monomers and the diluents results in a desired viscosity of the ink composition. The viscosity value can be in the range of about 1 centipoise to about 50 centipoise (e.g., from about 5 centipoise to about 45 centipoise, or from about 7 centipoise to about 35 centipoise) at a temperature ranging from about 20° C. to about 150° C. In some embodiments, the viscosity value can range from greater than or equal to 1, 5, 10, 15, 20, 25, 30, 35, 40, or 45 centipoise; and/or less than or equal to about 50, 45, 40, 35, 30, 25, 20, 15, 10, or 5 centipoise. For inks which require lower viscosity, one or more low molecular weight mono- or multi-functional monomers may be included. For inks which require higher viscosity, one or more multi-functional oligomers, polymers, or reactive polymers may be included.

Photoinitiating Systems

A photoinitiating system, e.g., a blend, in the inks is capable of initiating polymerization reactions upon irradiation (e.g., ultraviolet light irradiation), e.g., a blend capable of producing free radicals. The photoinitiating system may initiate a ring opening polymerization reaction, a free radical polymerization reaction, a cationic reaction, or a combination of these reactions, e.g., a combination of ring opening and free radical polymerization.

The photoinitiating system can include the following components: an aromatic ketone photoinitiator, an amine synergist, an alpha-cleavage type photoinitiator, and/or a photosensitizer. Each component is fully soluble in the monomers and/or diluents described above.

An aromatic ketone photoinitiator can be an aromatic ketone that undergoes homolysis by two processes (often simultaneously): fragmentation and hydrogen abstraction, in which the hydrogen abstraction occurs in the presence of a hydrogen donor. In general, the aromatic ketone has a benzophenone skeleton. Examples of the aromatic ketones include, but are not limited to, 4-phenylbenzophenone, dimethyl benzophenone, trimethyl benzophenone (Esacure TZT), and methyl O-benzoyl benzoate.

An amine synergist can be an amine, as well as a hydrogen donor with abstractable hydrogens. For example, the amine synergist is a tertiary amine. Examples of the amine synergists include, but are not limited to, 2-(dimethylamino)-ethyl benzoate, ethyl 4-(dimehtylamino)benzoate, and amine functional acrylate synergists (e.g., Sartomer CN384, CN373).

An alpha-cleavage type photoinitiator can be an aliphatic or aromatic ketone that undergoes homolysis at the alpha position of the carbonyl group by one process: fragmentation. Examples of the alpha-cleavage type photoinitiators include, but are not limited to, 2,2-dimethoxy-2-phenyl acetophenone, 2,4,6-trimethylbenzoyl-diphenylphosphine oxide, and 2-methyl-1-[4-(methylthio)phenyl-2-morpholino propan-1-one (Irgacure 907).

A photosensitizer can be a substance that either increases the rate of a photoinitiated polymerization reaction or shifts the wavelength at which the polymerization reaction occurs. The photosensitizer can extend the range of an alpha-cleavage type photoinitiator by absorbing radiation into the visible wavelength, and transferring the energy to the alpha-cleavage type photoinitiator. Examples of photosensitizers include, but are not limited to, isopropylthioxanthone (ITX), diethylthioxanthone, and 2-chlorothioxanthone.

Adjuvants

The inks may contain an adjuvant such as a vehicle (e.g., a wax or resin), a stabilizer, an oil, a flexibilizer, or a plasticizer. The stabilizer can inhibit oxidation of the ink. The oil, flexibilizer, and plasticizer can reduce the viscosity of the ink.

Examples of waxes include, but are not limited to, stearic acid; succinic acid; beeswax; candelilla wax; camauba wax; alkylene oxide adducts of alkyl alcohols; phosphate esters of alkyl alcohols; alpha alkyl omega hydroxy poly(oxyethylene); allyl nonanoate; allyl octanoate; allyl sorbate; allyl tiglate; rice bran wax; paraffin wax; microcrystalline wax; synthetic paraffin wax; synthetic paraffin and succinic derivatives; petroleum wax; synthetic petroleum wax; cocoa butter; diacetyl tartaric acid esters of mono and diglycerides; mono and diglycerides; alpha butyl omega hydroxypoly(oxyethylene)poly(oxypropylene); calcium pantothenate; fatty acids; organic esters of fatty acids; amides of fatty acids (e.g., stearamide, stearyl stearamide, erucyl stearamide (e.g., Kemamide S-221 from Crompton-Knowles/Witco)); calcium salts of fatty acids; mono & diesters of fatty acids; sucrose fatty acid esters; calcium stearoly-2-lactylate; Japan wax; lanolin; glyceryl hydroxydecanoate; glyceryl hydroxydodecanoate; oxidatively refined montan wax fatty acids,; polyhydric alcohol diesters; oleic acids; palmitic acid; d-pantothenamide; polyethylene glycol (400) dioleate; polyethylene glycol (MW 200-9,500); polyethylene (MW 200-21,000); oxidized polyethylene; polyglycerol esters of fatty acids; polyglyceryl phthalate ester of coconut oil fatty acids; shellac wax; hydroxylated soybean oil fatty acids; stearyl alcohol; and tallow and its derivatives.

Examples of resins include, but are not limited to, acacia (gum arabic); gum ghatti; guar gum; locust (carob) bean gum; karaya gum (sterculia gum); gum tragacanth; chicle; highly stabilized rosin ester; tall oil; manila copais; corn gluten; coumarone-indene resins; crown gum; damar gum; p, alpha-dimethylstyrene; gum elemi; ethylene oxide polymer and its adducts; ethylene oxide/propylene oxide copolymer and its adducts; galbanum resin; gellan gum; ghatti gum; gluten gum; gualac gum; guarana gum; heptyl paraben; cellulose resins, including methyl and hydroxypropyl; hydroxypropyl methylcellulose resins; isobutylene-isoprene copolymer; mastic gum; oat gum; opopanax gum; polyacrylamide; modified polyacrylamide resin; polylimonene; polyisobutylene (min. MW 37,000); polymaleic acid; polyoxyethylene derivatives; polypropylene glycol (MW 1200-3000); polyvinyl acetate; polyvinyl alcohol; polyvinyl polypyrrolidone; polyvinyl pyrrolidone; rosin, adduct with fumaric acid, pentaerythritol ester; rosin, gum, glycerol ester; rosin, gum or wood, pentaerythritol ester; rosin, gum or wood, partially hydrogenated, glycerol ester; rosin, gum or wood, partially hydrogenated, pentaerythritol ester; rosin, methyl ester, partially hydrogenated; rosin, partially dimerized, glycerol ester; rosin, partially hydrogenated; rosin and rosin derivatives; rosin, polymerized, glycerol ester; rosin, tall oil, glycerol ester; rosin, wood; rosin, wood, glycerol ester; purified shellac; styrene; styrene terpolymers; styrene copolymers; sucrose acetate isobutyrate; terpene resins, natural and synthetic; turpentine gum; vinylacetate; vinyl chloride-vinylidene chloride copolymer; zanthan gum; and zein.

Examples of stabilizers, oils, flexibilizers and plasticizers include, but are not limited to, methylether hydroquinone (MEHQ); hydroquinone (HQ); Genorad 16 (a free radical stabilizer from Rahn Corp.); butylated hydroxyanisole (BHA); butylated hydoxytoluene (BHT); propyl gallate; tert-butyl hydroquinone (TBHQ); ethylenediaminetetraacetic acid (EDTA); methyl paraben; propyl paraben; benzoic acid; glycerin; lecithin and modified lecithins; agar-agar; dextrin; diacetyl; enzyme modified fats; glucono delta-lactone; carrot oil; chincona extract; rapeseed oil; pectins; propylene glycol; peanut oil; sorbitol; acetophenone; brominated vegetable oil; polyoxyethylene 60 sorbitan mono stearate; olestra; castor oil; oiticia oil; 1,3 butylene glycol; coconut oil and its derivatives; corn oil; substituted benzoates; substituted butyrates; substituted citrates; substituted formates; substituted hexanoates; substituted isovalerates; substituted lactates; substituted propionates; substituted isobutyrates; substituted octanoates; substituted palmitates; substituted myristates; substituted oleates; substituted stearates, distearates and tristearates; substituted gluconates; substituted undecanoates; substituted behenates; substituted succinates; substituted gallates; substituted heptanoates; substituted phenylacetates; substituted cinnamates; substituted 2-methylbutyrates; substituted tiglates; corn syrup; isoparaffinic petroleum hydrocarbons; mineral oil; glycerin; mono- and diglycerides and their derivatives; olibanum oil; opopanax oil; peanut oil; polysorbates 20, 60, 65, 80; propylene glycol mono- and diesters of fats and fatty acids; epoxidized soybean oil; hydrogenated soybean oil; sperm oil; and hydrogenated sperm oil.

Other Ink Components

The ink composition can also include a polymeric dispersant. The polymeric dispersant can assist in stabilizing the colorant in the ink. The dispersant can, for example, prevent agglomeration of the colorant. The ink can include between about 1% and 10% by weight dispersant (e.g., between about 3% and 8% by weight dispersant).

Examples of dispersants include Solsperse 13,650, 13,940, 17,000, 24,000, 32,000, 36,000; Byk 108; Tego Dispers 700; UNIQEMA 5543; and EFKA 5244, 5207, 6750; which are all commercially available from Avecia; Byk Chemie; Tego Chemie; Zephryn Uniquema; and EFKA additives, respectively.

The amount of dispersant required is generally based on the amount of colorant in the ink (e.g., the surface area of pigment particles in grams per meter squared). The dispersant used typically depends on ink composition including. The selected dispersant can be soluble in the vehicle, can lack volatility at an elevated temperature (e.g., 120° C.), and can have good affinity for the pigment. The dispersant can also include a synergist that aids dispersion.

In addition to or in place of a dispersant, a surfactant compound can be used. The surfactant compound can serve to alter the surface tension of the ink, and can be an anionic, cationic, nonionic or amphoteric surfactant compound, such as those described in McCutcheon's Functional Materials, North American Edition, Manufacturing Confectioner Publishing Co., Glen Rock, N.J., pp. 110-129 (1990). Examples of surfactants include copolymers such as SILWET® copolymers including Silwet L-7604, available from Crompton, OSi Specialties division. The copolymers are generally comprised of ethylene oxide, propylene oxide, and/or silicone. Other examples of surfactants include 3M FC430 available from 3M of St. Paul, MN and F50-100 available from DuPont Chemicals of Wilmington, Del.

Methods of Marking

The methods generally include exposing an object having a masked colorant to an amount of radiation sufficient to unmask the colorant, thereby creating a marking on the object.

An example of the chemical process that occurs in the unmasking of a colorant is provided below:

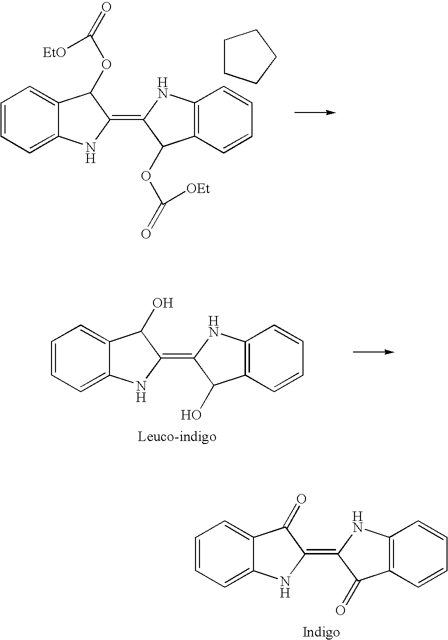

A colorless ethyl carbonate is the masked colorant component of the ink compositions, which is applied onto an object (e.g., using a flexographic printing method). The masked colorant is exposed to a light source, such as a diode laser (e.g., a CO₂ laser), the colored form is then liberated on exposure to light source. As shown above, the energy provided by the light source is sufficient to remove the protecting group. The unprotected leuco-indigo is subsequently oxidized, for example by exposure to air, thereby providing a colored indigo, which provides a marking.

Use of an absorber may enhance this reaction. Further, use of a blocked acid or base may serve to enhance this reaction.

As used herein, an “absorber” refers to a material that can produce thermal energy upon irradiation of electromagnetic radiation (e.g., from a laser). Without wishing to bound by theory, it is believed that the absorber can interact with (e.g., absorb) incident energy (e.g., energy having a wavelength of from approximately 400 nm to approximately 1,200 nm) and generate thermal energy from the incident energy. The thermal energy produced from the absorber can activate the thermally activatable coloring composition in a marking composition to form a mark. The absorber is generally stable under common environmental conditions (e.g., at room temperature and under atmospheric pressure). In some embodiments, the absorber is compatible with other materials in a marking composition (e.g., by not generating a color change upon mixing with other materials in the marking composition).

In some embodiments, the absorber contains particles having an average dimension (e.g., an average diameter) of at least approximately 0.1 micron (e.g., at least approximately 1 micron) and/or at most approximately 40 microns (e.g., at most approximately 20 microns, at most approximately 15 microns).

The absorber can have a maximum absorption in a broad range of wavelengths, depending, for example, on the particular marking composition and incident energy used. In some embodiments, an absorber has a maximum absorption wavelength from approximately 400 nm to approximately 1,200 rm (e.g., from approximately 460 nm to approximately 840 nm). Examples of absorbers include KF1151 PFNA, KF1152 PINA, KF1026 PINA, SDA7950, SDA1816, Photo dye KF 1126 PINA, Photo dye KF 1127 PINA, SDA 4927, SDD 5712, KF839TS, A-183, SDAI037, PJ 80ONP, and PJ 830NP. All KF PINA materials are available from Honeywell, Seelze GmbH (Seelze, Germany). All SDD and SDA are available from H. W. Sands (Jupiter, Fla.). PJ800NP and PJ830NP are available from Avecia (Manchester, UK). In some embodiments, an absorber has a maximum absorption wavelength from approximately 8,000 nm to approximately 12,000 nm. Examples of absorbers include hydrous aluminosilicates, Mearlin Magnapearl 3100 (41.0-53.0% titanium dioxide, 0.35-0.83% tin dioxide, 46.0-59.0% mica), Engelhard Alsibronz 6 Mica (100% mica (CAS #12001-26-2)), Neogen 2000 (China clay (CAS #86402-68-4)), ASP G90 Kaolin Clay (hydrous kaolin (CAS #1332-58-7)), and ASP 170 Kaolin Clay (100% hydrous kaolin powder or aluminum silicate (CAS #1332-58-7)). Mearlin Magnapearl 3100, Engelhard Alsibronz 6 mica, and ASP 170 and G90 are available from Engelhard Corp. (Iselin, N.J. or North Charleston, S.C.), and Neogen 2000 is available from Imerys (Paris, France).

In some embodiments, the absorber is substantially transparent within the 400-700 nm region. As used herein, a “transparent absorber” refers to a material that, when used in a marking composition, transmits at least about 80% (e.g., at least about 85%, at least about 90%) of light within the 400-700 nm region. In certain embodiments, the absorber has a white color or another suitable color.

A marking composition can include two or more different absorbers. In some embodiments, each absorber has a maximum absorption wavelength different from those of other absorbers. For example, an absorber having a maximum absorption at approximately 780 nm can be combined with another absorber having a maximum absorption at approximately 820 nm to provide a marking composition that has a broadened region of strong absorption within the entire range of 780-820 nm. Such compositions can be particularly useful if wavelength shifts occur with photonic energy sources due to increases in operating temperature.

In some embodiments, the absorber(s) is at least approximately 1 wt % (e.g., at least approximately 4 wt % or at least approximately 8 wt %), and/or at most approximately 20 wt % (at most approximately 16 wt % or at most approximately 12 wt %) of a marking composition. For example, a marking composition can include approximately 10 wt % of the absorber(s). In other embodiments, e.g., for absorbers that absorb at approximately 808 nm, the absorber is at most approximately 1 wt %, or at least approximately 0.05 wt % of a marking composition.

Examples of blocked acids include the following, amine salts of para-toluene sulfonic acid, such as Nacure 2170 (King Industries Inc., Norwalk, Conn.), which is described as a para-toluene sulfonic acid with an activation temperature of 90° C. may be used. The amine group, which acts as a blocking group and is used in creating the salt, can be responsible for the temperature where the acid is regenerated through decomposition of the ionic pair, thereby providing a trigger for color development. By knowing when the acidic moiety is formed (e.g., the melting point of the solid material, when a structural change occurs, or the activation temperature of blocked acid) and selecting the desired color developer, a desired color development can be achieved. Also, by selecting the appropriate color developer, certain events, such as premature color development from interactions between the acid and the leuco dye caused by a lamination process, can be prevented.

In some preferred embodiments, the ink composition is applied to a subtracting using flexography printing, which is a process commonly used to print packaging materials such as corrugated containers, folding cartons, multiwall sacks, laminated sacks, paper sacks, plastic bags, milk and beverage cartons, disposable cups and containers, labels, adhesive tapes, envelopes, newspapers, and wrappers (candy and food).

In some embodiments, the ink composition is printed directly onto a substrate.

In some embodiments, the ink composition is applied to a laminated object, such as a disposable packaging for a food product. The ink is generally applied between a base layer and a laminate, for example a semi-porous laminate. The ink composition can be applied at any time convenient in the packaging process. Upon application of the ink composition, the colorant is in the masked form. The colorant can be unmasked upon application of radiation sufficient to shift the masked colorant to an unmasked state, thereby providing a marking.

In some embodiments, the ink composition is applied to an object a least about 1 hour (e.g., at least about 2 hours, at least about 4 hours, at least about 12 hours, at least about 1 day, at least about 2 days, at least about 3 days, at least about 1 weeks, at least about 2 weeks, at least about 1 month, at least about 2 months, at least about 3 months, at least about 4 months, at least about 5 months, or at least about 6 months,) before the ink composition is treated with energy sufficient to unmask the colorant.

Radiation Source

Examples of radiation sources (e.g., a laser beam source employable herein) include eximer laser, argon laser, helium neon laser, semiconductor laser, glass (YAG) laser, carbon dioxide gas laser, and dye laser. Useful among these laser beam sources are helium neon laser, semiconductor laser, and glass laser. In preferred embodiments, the colorant is unmasked using a laser, such as a CO₂ diode laser. It is preferred that the colorant be unmasked using a power of less than about 10 W, e.g., less than about 9 W, less than about 8 W, less than about 7 W, less than about 6 W, less than about 5 W, less than about 4 W, less than about 3 W, less than about 2 W or less than about 1 W. It is preferred that the colorant be unmasked using an energy source of less than about 10 J/cm², less than about 9 J/cm², less than about 8 J/cm², less than about 7 J/cm², less than about 6 J/cm², less than about 5 J/cm², less than about 4 J/cm², less than about 3 J/cm², less than about 2 J/cm², or less than about 1 J/cm².

In preferred embodiments, the radiation is greater than about 1000 nm.

Other methods of marking are described in U.S. Ser. No. 11/438,469, METHODS OF MARKING AND RELATED STRUCTURES AND COMPOSITIONS, filed May 22, 2006, which is incorporated by reference herein in its entirety.

Marking

In some preferred embodiments, the masked colorant is unmasked to provide an indicia onto an object, such as a packaging material. For example, the indicia can be a date on which the item in the packaging material was packaged, a date by which the packaged item should be used or consumed, or a bar code or other product identification mark.

A number of embodiments of the invention have been described. Nevertheless, it will be understood that various modifications may be made without departing from the spirit and scope of the invention. Accordingly, other embodiments are within the scope of the following claims.

What is claimed is:

1. A method of unmasking a masked colorant, the method comprising exposing an object coated with the masked colorant to radiation having a power less than 10 W and a wavelength of greater than about 800 nm thereby unmasking the masked colorant to produce a change in color of the object coated with the masked colorant.

2. The method of claim 1, wherein the radiation has a power of less than about 5 W.

3. he method of claim 2, wherein the radiation has a power of about 1 W.

4. The method of claim 1, wherein the radiation has an energy less than about 7 J/cm².

5. The method of claim 1, wherein the wavelength of the radiation is greater than about 1000 nm.

6. The method of claim 5, wherein the wavelength of radiation is between about 1050 nm and about 1075 nm.

7. The method of claim 1, wherein the masked colorant is an organic colorant.

8. The method of claim 1, wherein the masked colorant is a protected colorant and the unmasking comprises the deprotection of a protected colorant.

9. The method of claim 1, wherein the masked colorant is an indigo precursor.

10. The method of claim 9, wherein the indigo precursor is an indigo compound in the leuco form.

11. The method of claim 10, wherein the leuco form is a protected leuco form.

12. The method of claim 11, wherein the protected leuco form comprise a carbonate protecting group.

13. The method of claim 12, wherein the carbonate protecting group is an ethyl carbonate or a t-butyl carbonate.

14. The method of claim 1, wherein the masked colorant is a methylene blue precursor.

15. The method of claim 1, wherein the masked colorant has been layered with TiO2.

16. The method of claim 1, wherein the object comprises multiple layers and the coating of masked colorant is positioned between two layers.

17. The method of claim 1, wherein the coating of masked colorant is not directly open to air.

18. The method of claim 1, wherein the colorant is a component of a composition substantially free of organic solvent.

19. The method of claim 18, wherein the composition is a hot melt ink.

20. The method of claim 1, wherein the unmasked colorant produces an indicia on an object.

21. A multilayered object comprising
a first layer and a second layer; and
a masked colorant between the first layer and second layer.
